(19) United States
(12) Patent Application Publication
(10) Pub. No.: US 2008/0294723 A1
(43) Pub. Date: Nov. 27, 2008

(54) Business Process Automation

(75) Inventors: Marc J. Daniels, New York, NY (US); Alexandre Kornilovski, New York, NY (US); Julia Belfor, Brooklyn, NY (US); Gary Dmitriev, Middle Village, NY (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: Bank of America Corporation, Charlotte, NC (US)

(21) Appl. No.: 11/752,216

(22) Filed: May 22, 2007

(51) Int. Cl. G06F 15/16

(52) U.S. Cl. 709/205

(57) ABSTRACT

System and methods are disclosed for generating a document in a collaborative manner. A user may create data elements and activity elements, and associate the appropriate elements with events. Subsequently, when events occur, messages are sent to designated users to focus their attention on performing particular tasks, such as the task of updating data in a data store. A server computer may operate upon one or more of the elements in the data store to provide a message-based database system. Other users, including the lead user, may be assigned responsibilities associated with one or more of the elements in the data store. The various elements stored in the data store may be depicted in a tree format to assist in the visual layout of the numerous processes at work in the system. Using a template, a formatted user-friendly report may be generated that incorporates at least some of the data elements in the system.

### FIELD OF TECHNOLOGY

Aspects of the disclosure relate to business process. More specifically, aspects of the disclosure relate to tools and techniques for enhancing business process management.

### BACKGROUND

Companies have been using business process management to enhance productivity for years now. Many of these companies are driven by a desire to change business process to make their company more productive. Productivity is especially important when a business is growing in revenue and sales, but is not simultaneously hiring new employees to account for any added work. Current office tool sets are inadequate to provide employees with the productivity enhancements they need to keep up with the increased growth of activity related to their positions. In addition such tools (e.g., word processor, spreadsheet, etc.) are personal in nature and provide employees with only a limited level of productivity as it relates to collaborative activities. There is a need for tools and techniques that address shortcomings with these personal toolsets. The required enhancements cannot lead to the need for expensive software application re-installations/updates on hundred (or maybe thousands) of end user computers.

Computing that permits some basic activity-centric collaboration among multiple users is also known in the art. Although some of the current tools allow for some form of management of information, they fail to allow for automation of the process of collecting and publishing information at the employee controlled level. In general, prior systems were used to manage the volume of work (e.g., better scheduling and making information more visible), but they failed to reduce the actual volume of work (e.g., reminder sending/management, cut and paste activity, file and format conversion).

Furthermore, in recent years, legislation has heightened requirements for auditing and document management. Banks, financial institutions, consulting firms, and others are required to maintain certain protocols and procedure need systems and techniques for enhancing their ability to monitor activity on the private and public side. These requirements reduce the applicability of current software tools (word processing, spreadsheets, powerpoint) as the outputs are private in nature.

Therefore, there exists a need in the art for an innovation that enhances productivity and efficiency among members of an organization while being amenable to rigorous auditing.

### BRIEF SUMMARY

Aspects of the present disclosure address one or more of the issues mentioned above by disclosing techniques for automated collaborative data gathering, monitoring that process and generating one or more report outputs. The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In one embodiment in accordance with aspects of the disclosure, a method is illustrated for generating a document/report in a collaborative manner. The method includes creating data elements and activity elements, and associating the appropriate elements with events. Subsequently, when events occur, messages are sent to users to request their attention to particular tasks (e.g., the task of updating data). A report may be generated that incorporates at least some of the data elements. A template may be used to format the report.

In some embodiment in accordance with aspects of the disclosure, a system is illustrated for populating data in a memory in a collaborative manner. A lead user may create associations between various elements stored in a data store. A server computer may operate upon one or more of these elements in the data store to provide, in one example, a message-based database system. Other users, including the lead user, may be assigned responsibilities associated with one or more of the elements in the data store. The system may automatically, upon being triggered by a predetermined event, contact such users to remind them about their pending responsibilities. The various elements stored in the data store may be depicted in a tree format to assist in the visual layout of the numerous processes at work in the system.

Regarding yet another embodiment in accordance with aspects of the disclosure, one skilled in the art will appreciate that one or more of the aforementioned methods and features may be embodied as computer-executable instructions stored on a computer-readable medium and executed by a processor. In addition, a graphical user interface is described for depicting the various data elements, activity elements, and other items in a tree hierarchy with drag and drop functionality. Moreover, items in the graphical depiction may be color-coded and/or stylized to identify additional information about the status of the item/process.

### BRIEF DESCRIPTION OF THE DRAWINGS

The present disclosure is illustrated by way of example and not limited in the accompanying figures in which like reference numerals indicate similar elements and in which:

FIG. 1 illustrates a schematic diagram of a general-purpose digital computing environment in which various aspects of the disclosure may be implemented;

FIG. 2 shows an illustrative operating environment in which various aspects of the disclosure may be implemented; and

FIG. 3 shows an illustrative method for generating a document in accordance with various aspects of the disclosure.

### DETAILED DESCRIPTION

In accordance with various aspects of the disclosure, illustrative systems and techniques for generating a report in a collaborative manner are disclosed. Such a system may, once initiated, greatly automate mundane repetitive tasks in the business process of many organizations, including banks and financial institutions. The system may result in, among other things, an increase in worker productivity. Of course, one of ordinary skill in the art will appreciate that the accompanying disclosure and figures may enhance industry in numerous ways, including, but not limited to auditing and monitoring of employees.

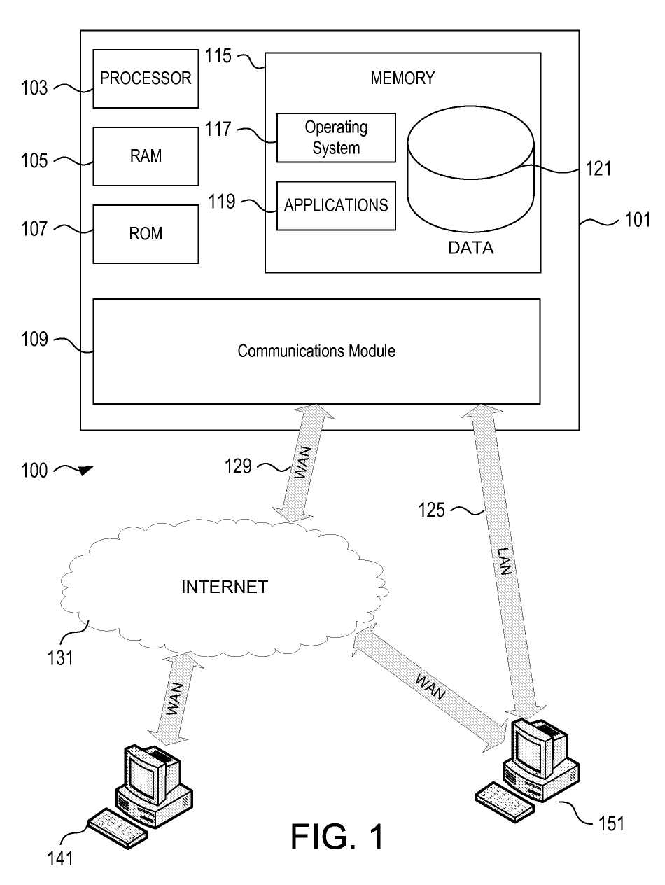

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computing device 101 having a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 101. Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). As described in detail below, the database 121 may provide centralized storage of account information and account holder information for the entire business, allowing interoperability between different elements of the business residing at different physical locations.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. The network connections depicted in FIG. 1 include a local area network (LAN) 125 and a wide area network (WAN) 129, but may also include other networks. When used in a LAN networking environment, computing device 101 is connected to the LAN 125 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computing device 101 according to an illustrative embodiment of the invention may include computer executable instructions for invoking user functionality related to communication, such as email, short message service (SMS), and voice input and speech recognition applications.

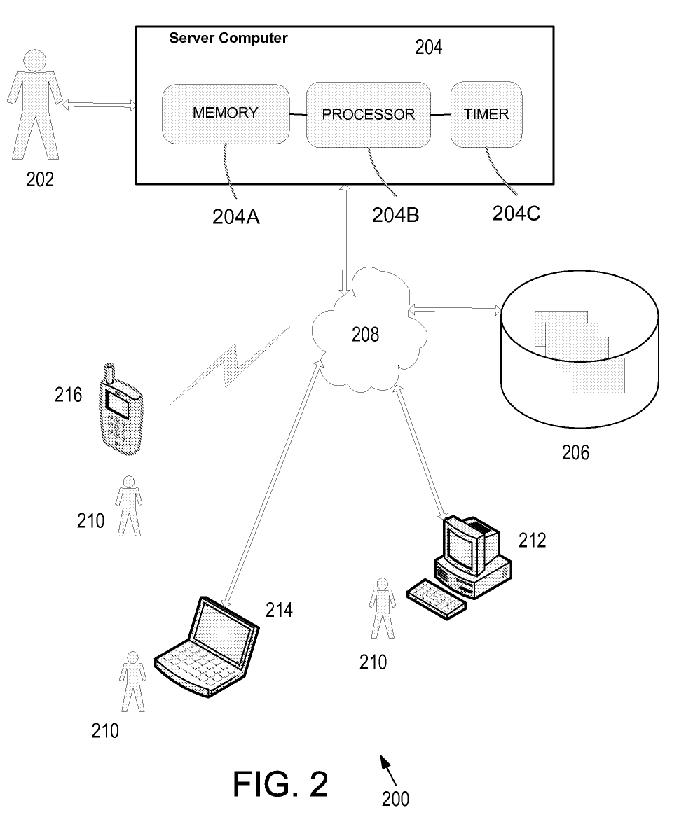

FIG. 2 illustrates an example of a suitable operating environment in which various aspects of the disclosure may be implemented. Such a system 200 may be used to populate a data store 206 in a collaborative manner. The data store 206, in one example, may be a networked high-capacity storage device (e.g., a R.A.I.D. drive, etc.) The data store 206 may store, among other things, a plurality of data elements, a plurality of activity elements, and a plurality of user profiles. The data elements may be represented by an area in memory allocated for storing data values. In one example, a data element may be created to hold the title of a report. In another example, a data element may be created to store an image of a pie graph. One skilled in the art will appreciate that a data element may be created as one or more of numerous types of data structures (e.g., Boolean, character, floating, etc.) well known in the art.

Furthermore, one or more activity elements may be linked to a data element. In one example using a graphical user interface, a user (e.g., a lead user 202) may drag and drop an activity element icon on a data element to associate the two. The association between the elements (e.g., data element to activity element, data element to data element, activity element to activity element, etc.) may be organized in a tree-like manner in a public webspace in the memory 204A of the server computer 204. A user may interact with the public webspace (e.g., memory allocated for a user's homepage) through a web server running on the server computer 204. For example, the root (i.e., topmost node) of the tree-like structure may hold the element representing the report. The hierarchy of data elements dependent off the root element may be assigned to various data points for the report to be generated. Meanwhile, activity elements may be associated with any of the data elements (including the root element). Therefore, a team leader may be assigned to the root element while subordinate project managers may be assigned to the various data elements depending off the root element. As such, the regional manager may gather and generate reports in accordance with aspects of the disclosure.

Furthermore, the activity element may be used to describe the action that is triggered upon the occurrence of a designated event. The action may, in one example, result in a request for an update of an associated data element. The activity element may comprise an association with one or more data elements, identification of a responsible user 210, and/or other information related to the responsible user 210 (e.g., e-mail address, mobile phone number, address, security privileges/access rights in a user profile, etc.).

As explained in the example above, a lead user 202 may create associations between a plurality of data elements and a plurality of activity elements. The lead user 202 may be a project manager, team leader, or any other person responsible for collecting data to generate a report. The lead user 202 may also be responsible for creating associations between the plurality of activity elements and a plurality of responsible users 210. A responsible user 210 may be any person assigned the responsibility of providing data values that may be used by a lead user 202 in generating a report. In one example, a responsible user 210 may be in a position subordinate to the lead user 202. In another example, a responsible user 210 may be an employee in a different division/department of an organization (e.g., a company) that may provide input for a report. As such, the system 200 provides an enhanced collaborative nature for gathering data and generating a report.

The responsible users 210 may use a personal computing device (e.g., a personal digital assistant (PDA 216), a laptop computer 214, a workstation computer 212, etc.) to provide a data value for a data element. The personal computing device may comprise a memory, processor, and/or other components, such as wireless communications hardware, keypad, stylus, visual display, and other components show in computing device 101 in FIG. 1. The responsible user 210 may communicate using such devices over a network 208 with a server computer 204 and/or data store 206. The responsible user 210 may receive a message (e.g., e-mail message, SMS message, etc.) from a server computer 204 requesting information for storing in a data element stored on a data store 206. In one example, the message may contain a link (e.g., a hyperlink) to the location of the data element. In such an example, the responsible user 210 may directly enter a data value into the data element in the data store 206. In another example, the responsible user 210 may attach a data file containing information for the data element.

The extent of the responsible user's 210 ability to read, modify, and/or delete data values in a data element may be based on a user profile associated with the responsible user 210. For example, a user profile may include various security permissions, which are well-known to those of skill in the art, to control the user's ability to manipulate data in the data store. At least one benefit of such a configuration is the ability of an organization to control which employees have access to particular data and to monitor how employees are contributing to reports. This may be particularly useful in a financial or banking context for auditing purposes (e.g., to enforce a partition between the private side and public side of the organization, and to identify any breaches in such a partition.)

For example, if a document file (e.g., spreadsheet) is local to a single user's personal workstation, then the document may be difficult to track and audit. Even object linking and embedding (OLE) features in word processing programs do not overcome this drawback because the file continues to remain on a user's local area. However, by storing the data on a data store 206 accessible to multiple users 202, 210, the file is moved from a personal computing space to a “public space.” The file may, as a result, be audited more efficiently/productively for regulatory compliance (e.g., Sarbanes-Oxley). In general, activities which are executed within the associate's web workspace are auditable to the same extend as collaboration executed through larger enterprise based systems with additional benefits (e.g., without the cost of enterprise sized systems.)

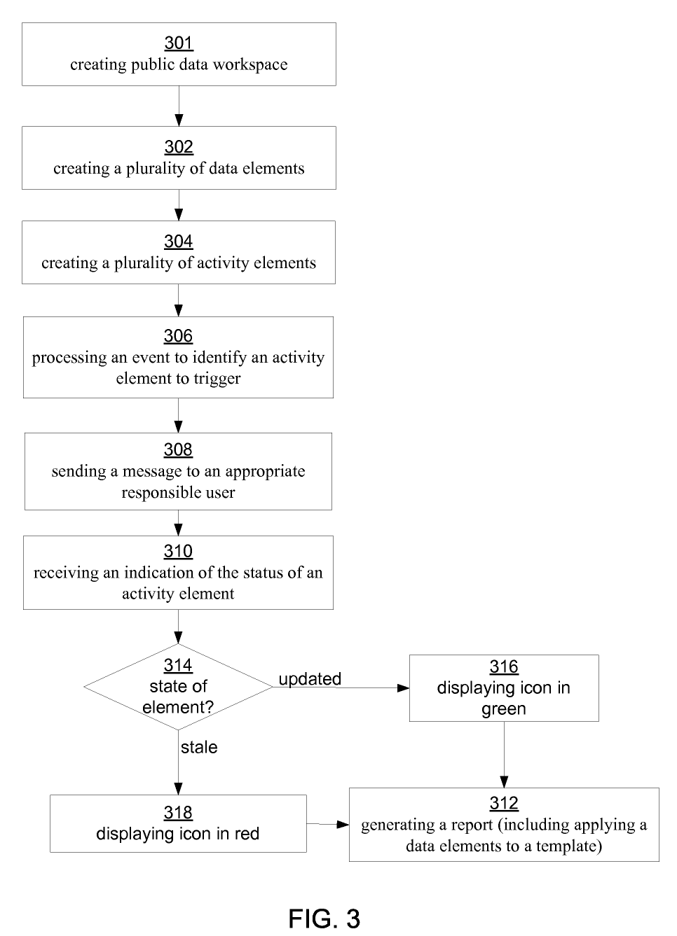

Referring to FIG. 2, the lead user 202 may interact with a server computer 204 comprising a processor 204B and a memory 204A. The memory 204A may hold computer-executable instructions that, when executed by the processor 204B, cause the server computer 204 to perform a method in accordance with aspects of the disclosure. In one example, the server computer 204 may perform one or more of the steps illustrated in FIG. 3. As such, the server computer 204 may include, as appropriate, one or more of the components illustrated in computing device 101 in FIG. 1. The lead user 202 may interact directly with the server computer 204, or alternatively, through a web interface (i.e., an Internet browser or similar software on may be used to access the functionality on the server computer 204 through a network 28 such as the Internet.)

One skilled in the art will appreciate that the disclosure contemplates various architectures for implementing one or more aspects of the disclosure. For example, in a thin-client architectural approach, the personal computing devices 212, 214, 216 of the responsible users 210 may be used merely to present information and receive input. Rather, most of the processing and computations may occur at the server computer 204. As such, the software running the personal computing devices 212, 214, 216 used to interact with the server machine 204 and/or data store 206 may require only a minimal memory footprint. In one example, such software may simply be an Internet browser (e.g., Internet Explorer, etc.) accessing a webpage on the server computer 204. Meanwhile, in a fat-client architectural approach, the personal computing devices 212, 214, 216 of the responsible users 210 may contain installed software that requires a more substantial memory footprint and computational resources. In such an example, any updates to the software may require updating the computer-executable instructions on the server computer 204 as well as each personal computing device 212, 214, 216. One skilled in the art will appreciate that the depiction in FIG. 2 is merely one example of an implementation of the disclosure and that various architectural approaches are contemplated by the disclosure.

In another embodiment in accordance with aspects of the invention, a timer 204C configured to, among other things, generate an event at a predetermined interval of time may be included in the server computer 204. The timer 204C may trigger an activity element at a regular interval (e.g., weekly, annually, bimonthly, bi-weekly, monthly, daily, etc.) by generating an event at the appropriate time. In one example, the responsible users 210 associated with a particular report may receive a message (e.g., e-mail message) one week before the first of each month indicating that their input is requested for particular data elements. The activity elements associated with each responsible user 210 in such an example may include a triggering event based on time. However, various aspects of the invention are also contemplated where the triggering event in an activity element is based on other considerations (e.g., manual request by a lead user 202, data elements going into an obsolete state, etc.) and will become apparent to one skilled in the art after review of the entirety.

Referring to FIG. 3, one method for generating a document in a collaborative manner in accordance with various aspects of the disclosure is illustrated. In step 301, a public workspace may be created. In step 302, a plurality of data elements are created. The plurality of data elements may be associated with a user's public workspace using software (e.g., tools) in accordance with aspects of the disclosure. As such, data and activities based off (e.g., created using or within) the user's public (e.g., web-based) workspace may be auditable to the same extent as collaboration executed through larger enterprise based systems, however, without the cost of enterprise sized systems. The public workspace may provide various software tools for the user to use through the public workspace. In addition, the plurality of data elements may be stored in a data store 206 that is configured, in one example, to be accessible to a plurality of users (e.g., responsible users 210). The plurality of users may update such data elements as requested (or alternatively, as desired) in the commonly accessible storage area. At least one benefit of a centralized storage for data is the enhanced auditing capabilities and monitoring capable with such a configuration. For example, an auditing team may monitor which users 210, 202 were involved in the generation of a particular report. In one example, a log file may be maintained to track which users have accessed and/or modified particular data elements and/or reports.

In step 304, a plurality of activity elements may be created. In one example, a lead user 202 may create a tree hierarchy comprising a plurality of data elements. Each data element may be associated with an activity element of the plurality of activity elements stored in a data store 206. The activity elements may be created automatically by the system 200 or manually by a lead user 202. In some examples, a set of default activity elements may be automatically created that correspond to basic functionality (e.g., an activity element for sending an e-mail message to a particular responsible user 210, etc.) of the system 200. In some advanced configurations, a lead user 202 may create specialized activity elements that trigger upon the occurrence of multiple conditions, or result in the occurrence of multiple actions after being triggered. At least one benefit of such message-enabled data structures in system 200 is that the information in the data structures may be automatically requested and gathered upon the occurrence of triggering events. Once a lead user 202 creates a tree with the appropriate elements, the manual work required to organize and generate a report is effectively eliminated. The system 200 may automatically request data and update the visual status indicator (e.g., whether the responsible user 210 has updated the requested data or whether the data is currently outdated) of the elements accordingly.

In step 306, an event may be processed to identify and trigger at least one activity element of the plurality of activity elements stored in a data store 206. In one example, the event may be based on time. In such an embodiment, a timer 204C may be used to track an interval of time and generate a time-based event at the appropriate interval. In another example, the event may be based on a manual request, such as when a lead user 202 directs a server computer 204 to trigger activity elements relating to a particular data element or report. The manual request may be used to force the system 200 to initiate the process of updating data elements. In yet another example, the event may be based on a change in the state of a data element. Such an embodiment may be used, for example, to trigger the updating of data elements if the data element corresponding to a company's revenue falls below a threshold value. The decrease in revenue may be an early symptom foretelling additional troubles, thus the system 200 request data element updates so that a new report may be generated.

In step 308, a message may be sent to a responsible user 210 associated with the activity element identified as being triggered. In one example, the message may include an e-mail message requesting information for an associated data element. In another example, the message may include an SMS message requesting information for an associated data element. In yet another example, the message may include an audible message (e.g., a voicemail) requesting information for an associated data element. One skilled in the art will appreciate after review of the entirety herein that there exist other ways of communicating a request to a responsible user 210 and are contemplated by the disclosure.

In accordance with various embodiments of the disclosure, the message may include a request for the responsible user 210 to indicate a file (e.g., filename, path, etc.) for the associated data element. The contents of such a file may be copied to the memory location in the data store 206 allocated to the associated data element. The message may include a hyperlink that a responsible user 210 may use to provide information that will be sent for storage in the associated data element.

In step 310, an indication corresponding to a responsible user 210 having completed the activity element may be received. The data elements and/or activity elements may be rendered in a predetermined color to indicate that the information is not up-to-date. Meanwhile, these elements may be rendered in a different predetermined color if the information was recently updated. The varied colors may permit a lead user 202 to more efficiently review the status of data elements prior to any report generation. For example, a graphical icon corresponding to a particular data element may be displayed in red to indicate that an update of the data values may be necessary. Once a responsible user 210 updates the data element (e.g., by providing updated information), the graphical icon may be displayed in green. In step 314, depending on the state of the data element and/or activity element: if the current state is updated, then the graphical icon may be displayed (in step 316) in green; but if the current state indicates stale data (e.g., not yet updated data, incorrect data, etc.), then the graphical icon may be displayed (in step 318) in red. In other words, the disclosure contemplates the color of a graphical item being changed to indicate a state of a task (e.g., action in the activity element) and/or data in the system 200.

Furthermore, in step 312, a report may be generated. The report may include one or more of the plurality of data elements in the data store 206. For example, a lead user 202 may initiate the generation of a report either manually (e.g., by selecting a button on a graphical user interface) or on an automated basis (e.g., the system automatically generating reports at the end of each month, or after all users 210 have provided updated data, etc.) In addition, the lead user 202 may create multiple different reports from a given set of data elements. In one example, a first template may be applied to the data elements to generate a report for internal purposes. Meanwhile, a second template may be applied to the data elements to generate a different report that may be used for external (i.e., for dissemination to individuals outside the organization) purposes. As such, a data store 206 and/or memory 204A may store one or more templates for formatting the presentation of the data elements in a generated report. Furthermore, in one example, the report may be text-based (e.g., viewable in Microsoft Word). Alternatively, the report may be output in a different format (e.g., Adobe PDF format, Excel format, etc.).

In one example, a system 200 may include programming code (e.g., Visual Basic code) that extracts data values from the appropriate data elements in the data store 206 and puts them in a default format (e.g., following the same logical sequence they appear in the graphical user interface). Alternatively, the format may be dictated by a template. The template may indicate the position to display data values pulled from particular data elements. The programming code may be executed by a processor 204B in a server computer 204. In another example, built-in functionality in word processor (e.g., Microsoft Word) may be used to insert tags directly into a document file that, when executed, will automatically extract the appropriate data values from a data store 206 and display in a formatted report.

In addition, in accordance with various aspects of the disclosure, scenario-based application (e.g., disaster recovery applications), on-line user databases, automated presentation (e.g., Powerpoint) update application, and custom project management applications (e.g., six sigma, waterfall, etc.) are disclosed. For example, a disaster recovery application may use system 200 to generate messages to all employees in an organization upon the occurrence of a disaster event (e.g., a fire, tornado, terrorist attack, etc.) and generate an automated report indicating the status of each employee. In another example, a project management application might generate requests for and updates to standard project documents artifacts. Meanwhile, a database application might request customer reporting from sales people attending a specific conference.

Furthermore, aspects of the disclosure may be applied to calculate and sum up all productivity gains of individual process automation. Such numbers may be useful to an organization's management in selecting individuals for promotion/demotion, and for business intelligence analysis (e.g., to reveal how productivity gains can be translated into organizational change and used to refocus technology strategy towards best productivity gains.)

Although not required, one of ordinary skill in the art will appreciate that various aspects described herein may be embodied as a method, a data processing system, or as a computer-readable medium storing computer-executable instructions. For example, one or more of the steps depicted in FIG. 3 and others described throughout the disclosure may be implemented as computer-executable instructions on a computer-readable medium and cause server computer 204 to perform the steps when executed by a processor 204B.

Moreover, aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

We claim:

1. A method for generating a document in a collaborative manner, comprising:
creating a plurality of data elements;
creating a plurality of activity elements, where each data element of the plurality of data elements is associated with an activity element of the plurality of activity elements;
processing an event to identify at least one activity element of the plurality of activity elements to trigger;
in response to triggering an activity element, sending a message to a responsible user associated with the at least one activity element;
receiving an indication corresponding to the responsible user having completed the activity element; and
generating a report including the plurality of data elements.

2. The method of claim 1, where the plurality of data elements are stored in a memory configured to be accessible to a plurality of users, and the plurality of data elements and the plurality of activity elements are associated in a tree-like manner.

3. The method of claim 1, the event being based on at least time.

4. The method of claim 1, the event being based on a manual request.

5. The method of claim 1, the event being based on a change in a state of a data element.

6. The method of claim 1, where the message comprises an e-mail message to the responsible user requesting information for an associated data element.

7. The method of claim 6, the message including a request for the responsible user to indicate a file for the associated data element.

8. The method of claim 6, the message including a hyperlink for the responsible user to use to enter a data value for the associated data element.

9. The method of claim 1, where the message comprises an SMS message to the responsible user requesting information for an associated data element.

10. The method of claim 1, where the message comprises an audible message to the responsible user requesting information for an associated data element.

11. The method of claim 1, comprising:
changing a color of an icon corresponding to the at least one activity element to indicate an updated status, where the at least one activity element enters the updated state after the responsible user enters a data value into the data element associated with the at least one activity element.

12. The method of claim 1, comprising:
receiving a data value from the responsible user for storing in a data element associated with the activity element.

13. The method of claim 1, where generating a report includes applying the plurality of data elements to a template.

14. A computer readable medium storing computer-executable instructions for causing a processor to perform a method comprising:
creating a plurality of data elements;
creating a plurality of activity elements, where each data element of the plurality of data elements is associated with an activity element of the plurality of activity elements;
processing an event to identify at least one activity element of the plurality of activity elements to trigger;
in response to triggering an activity element, sending a message to a responsible user associated with the at least one activity element;
receiving an indication corresponding to completion of the activity element; and

15. The computer-readable medium of claim 14, comprising:
generating a report including the plurality of data elements.

16. The computer-readable medium of claim 14, where the message comprises an SMS message requesting the responsible user enter a data value for the associated data element.

17. A system for populating a data store in a collaborative manner, comprising:
a lead user responsible for creating associations between a plurality of data elements and a plurality of activity elements and for creating associations between the plurality of activity elements and a plurality of responsible users;
a data store comprising the plurality of data elements and the plurality of activity elements; and
a server computer comprising a memory and a processor, where the memory comprises computer-executable instructions to cause the processor to perform a method comprising:
processing an event to identify at least one activity element of the plurality of activity elements to trigger;
in response to triggering an activity element, sending a message to a responsible user associated with the at least one activity element; and
generating a report including the plurality of data elements.

18. The system of claim 17, the data store comprising a plurality of user profiles including security permission, where the plurality of user profiles are associated with the plurality of responsible users.

19. The system of claim 18, where the plurality of responsible users provide data values for the plurality of data elements in response to receiving the message.

20. The system of claim 17, the server computer comprising a timer configured to generate an event at a predetermined interval of time.

21. The system of claim 18, the server computer including a web server where the lead user has a public webspace in the memory of the server computer.
